(19) United States
(12) Patent Application Publication
(10) Pub. No.: US 2006/0170884 A1
(43) Pub. Date: Aug. 3, 2006

(54) Optical projection apparatus

(76) Inventor: Chin-Ku Liu, Miao-Li County (TW)

Correspondence Address: J C PATENTS, INC., 4 VENTURE, SUITE 250, IRVINE, CA, 92618, US

(21) Appl. No.: 11/188,191

(22) Filed: Jul. 22, 2005

(30) Foreign Application Priority Data
Feb. 1, 2005 (TW) 94103005

(51) Int. Cl. G03B 21/14

(52) U.S. Cl. 353/100

(57) ABSTRACT

An optical projection apparatus includs an illumination system, a projection lens and a reflective light valve between the illumination system and the projection lens. The illumination system includes a first light source assembly, a second light source assembly, a first light integration rod, a second light integration rod and a dichroic mirror. A first light beam and a second light beam with different spectrum are provided by the first light source assembly and the second light source assembly, respectively. Moreover, the projection lens, the reflective light valve and the dichroic mirror are disposed on the transmission path of the first and the second light beam. The dichroic mirror allows the first light beam to pass through, and reflects the second light beam, to make the transmission path of the first and the second light beam identical.

### CROSS-REFERENCE TO RELATED APPLICATION

This application claims the priority benefit of Taiwan application serial no. 94103005, filed on Feb. 1, 2005. All disclosure of the Taiwan application is incorporated herein by reference.

### BACKGROUND OF THE INVENTION

1. Field of the Invention

The present invention relates to an optical projection apparatus, and more particularly, to an optical projection apparatus capable of projecting images with high brightness.

2. Description of the Related Art

FIG. 1A is a schematic diagram of an optical projection apparatus utilizing light emitting diode (LED) as the light source. FIG. 1B illustrates a structure of the light source assembly shown in FIG. 1A. Referring to FIGS. 1A and 1B, a conventional optical projection apparatus 100a includes an illumination system 110, a projection lens 120 and a digital micro-mirror device (DMD) 130. The digital micro-mirror device 130 is disposed between the illumination system 110 and the projection lens 120. Moreover, the illumination system 110 includes a light source assembly 112, a light integration rod 114 and a lens 116. The light integration rod 114 is disposed between the light source assembly 112 and the digital micro-mirror device 130. The lens 116 is disposed between the light integration rod 114 and the digital micro-mirror device 130.

The light source assembly 112 provides a light beam 113. The light beam 113 passes through the light integration rod 114 and the lens 116, and then propagates to the digital micro-mirror device 130. The digital micro-mirror device 130 comprises a plurality of micro-mirrors (not shown). When the micro-mirror is in “ON” state, the light beam 113 is reflected by the micro-mirror to the projection lens 120; and when the micro-mirror is in “OFF” state, the light beam 113 is deviated from the projection lens 120. Then, the light beam 113 reflected to the projection lens 120 is projected on screen (now shown) to form a image on the screen.

In the conventional technology, the light source assembly 112 is known to comprise red light emitting diode R, green light emitting diode G and blue light emitting diode B. Full color image is projected by the optical projection apparatus 100 through the red light, blue light and green light processed by the DMD 130. However, a conventional optical projection apparatus 100 only includes a single light source assembly 112, therefore the light beam 113 projected on the digital micro-mirror device 130 is relatively weak, such that the luminance of the image projected by the projection lens 120 is relatively low.

FIG. 2 is a schematic diagram of another conventional optical projection apparatus utilizing light-emitting diode (LED) as the light source. Referring to FIG. 2, a conventional method for improving the problems mentioned above is to utilize three light source assemblies 112a, 112b, 112c and dichroic mirrors 117a, 117b to collect lights to increase the image brightness. The light source assemblies 112a, 112b, 112c are blue, green and red light source assemblies respectively. The dichroic mirror 117a allows the blue light 112a′ to pass through and reflects the green light 112b′, and the dichroic mirror 117b allows the blue light 112a′ and green light 112b′ to pass through and reflects the red light 112c′. Therefore, the blue light 112a′, the green light 112b′ and the red light 112c′ are all transmitted to the digital micro-mirror device 130. Then, the image output from the DMD 130 is projected by the projection lens 120.

Since the projection apparatus 100b has three light source assemblies 112a, 112b, and 112c, the brightness of the projected image is increased. However, because the diverge angle of the beams provided by the light source assemblies 112a, 112b, and 112c (blue light 112a′, green light 112b′ and red light 112c′) is up to ±180 degree, and because of the limited convergence effect of condenser 118a, 118b, 118c, using these light beams with large diverge angle to converge lights would cause greater loss. Therefore, the brightness of the images projected by a conventional projection apparatus 100b can not be sufficiently increased.

### SUMMARY OF THE INVENTION

It is an object of the present invention to provide an optical projection apparatus capable of decreasing light loss during light collecting.

It is another object of the present invention to provide an optical projection apparatus capable of projecting images with high brightness.

As above embodied and broadly described herein, the optical projection apparatus of the present invention including an illumination system, a projection lens and a reflective light valve is provided. The reflective light valve is disposed between the illumination system and the projection lens. The illumination system includes a first light source assembly, a second light source assembly, a first light integration rod, a second light integration rod and a dichroic mirror. A first light beam and a second light beam with different spectrum are provided by the first light source assembly and the second light source assembly, respectively. Moreover, the projection lens, the reflective light valve and the dichroic mirror are disposed on the transmission path of the first and the second light beam. The dichroic mirror allows the first light beam to pass through, and reflects the second light beam, to make the transmission path of the first and the second light beam identical. Furthermore, the first light integration rod is disposed between the first light source assembly and the dichroic mirror. The second light integration rod is disposed between the second light source assembly and the dichroic mirror.

The optical projection apparatus in the present invention utilizes a plurality of light integration rods disposed between the light source assembly and the dichroic mirror. These light integration rods may make the original diverge angle ±180 degrees restrain to ±30 degrees so as to reduce the light loss during light collecting. Therefore, the optical projection apparatus in the present invention can project images with high brightness.

### BRIEF DESCRIPTION OF THE DRAWINGS

These and other exemplary embodiments, features, aspects, and advantages of the present invention will be described and become more apparent from the detailed description of exemplary embodiments when read in conjunction with the accompanying drawings.

FIG. 1A is a schematic diagram of a conventional optical projection apparatus utilizing LEDs as light source.

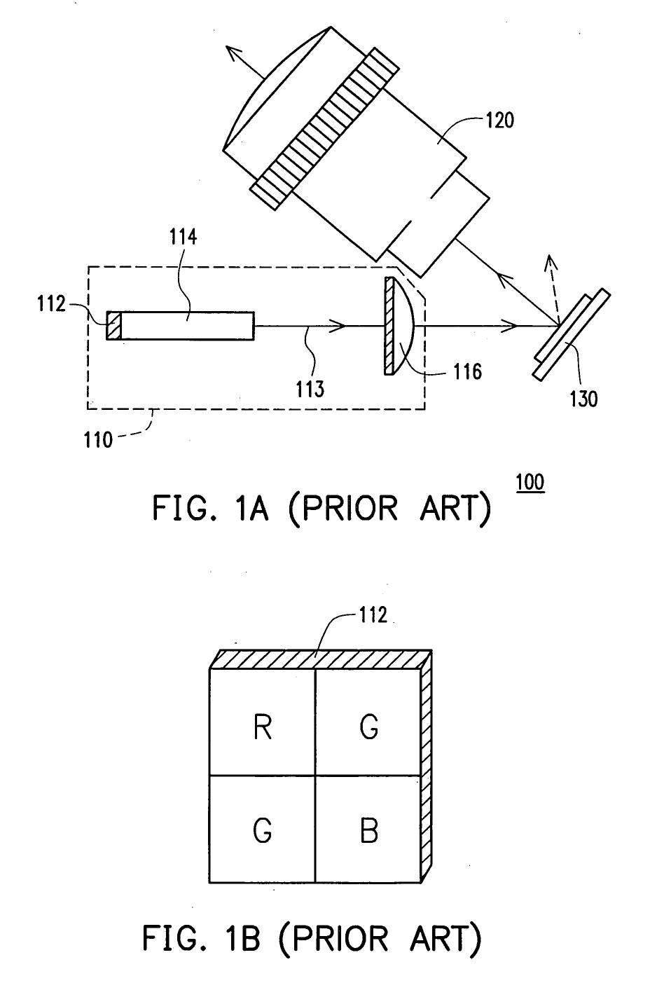

FIG. 1B is a schematic diagram of the light source assembly shown in FIG. 1A.

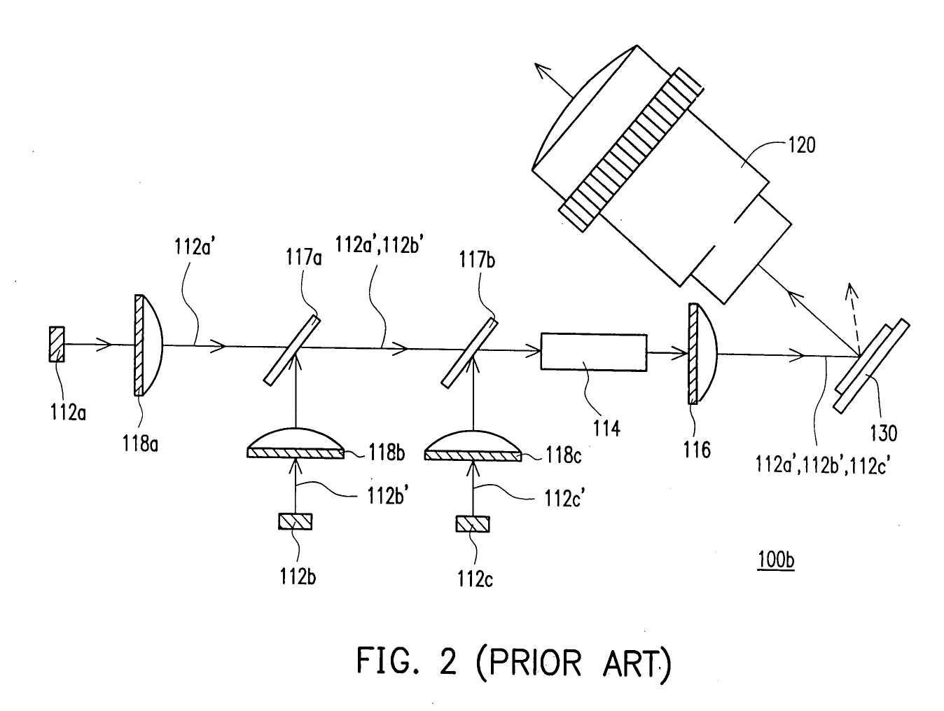

FIG. 2 is a schematic diagram of another conventional optical projection apparatus utilizing LEDs as light source.

FIG. 3 illustrates a diagram of an optical projection apparatus in accordance with an embodiment of the present invention.

FIG. 4 illustrates a structure of the first and second light source assembly in FIG. 3.

FIGS. 5A to 5C are schematic diagrams of the three optical projection apparatus in accordance with another embodiment of the present invention.

FIG. 6 illustrates a diagram of an optical projection apparatus in accordance with still another embodiment of the present invention.

FIG. 7 is a schematic diagram of the first light source assembly, the second light source assembly and the third light source assembly shown in FIG. 6.

FIG. 8 illustrates a diagram of an optical projection apparatus in accordance with yet another embodiment of the present invention.

### DETAILED DESCRIPTION OF THE EMBODIMENT

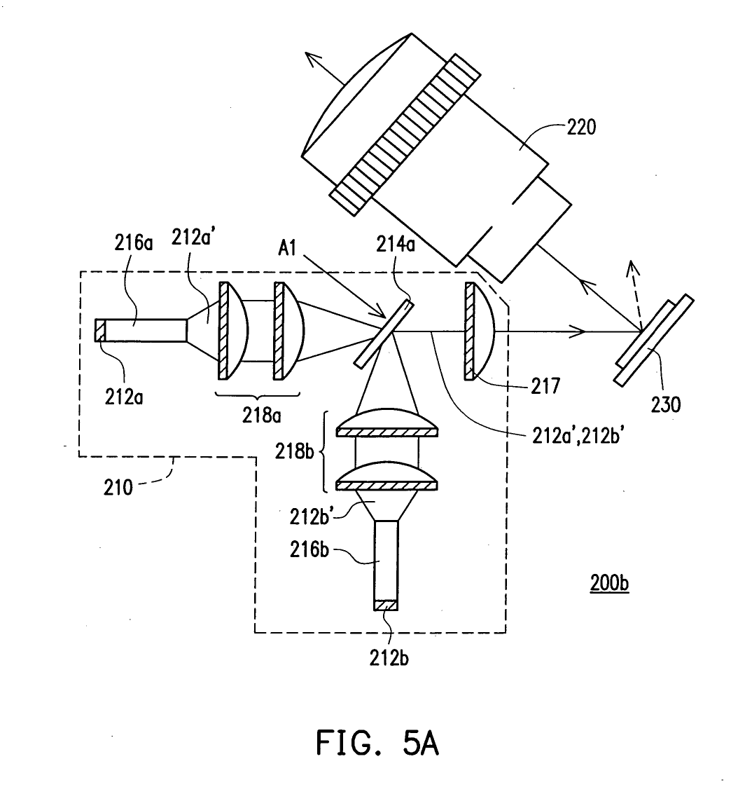

FIG. 3 illustrates a diagram of an optical projection apparatus in accordance with an embodiment of the present invention. Referring to FIG. 3, the optical projection apparatus 200a in the present embodiment includes an illumination system 210, a projection lens 220 and a reflective light valve 230. The reflective light valve 230 is disposed between the illumination system 210 and the projection lens 220. The illumination system 210 includes a first light source assembly 212a, a second light source assembly 212b, a first dichroic mirror 214a, a first light integration rod 216a and a second light integration rod 216b. A first light beam 212a′ and a second light beam 212b′ are provided by the first light source assembly 212a and the second light source assembly 212b, respectively. The spectrum of the first light beam 212a′ and the second light beam 212b′ are different. Moreover, the projection lens 220, the reflective light valve 230 and the first dichroic mirror 214a are disposed on the transmission path of the first light beam 212a′ and the second light beam 212b′. The first light beam 212a′ passes through the first dichroic mirror 214a, and the second light beam 212b′ is reflected by the first dichroic mirror 214a to make the transmission path of the reflected second light beam 212b′ coincide with the transmission path of the first light beam 212a′ passing through the dichroic mirror 214a. Furthermore, the first light integration rod 216a is disposed between the first light source assembly 212a and the first dichroic mirror 214a. The second light integration rod 216b is disposed between the second light source assembly 212b and the first dichroic mirror 214a.

In the optical projection apparatus 200a described above, the illumination system 210 further includes a lens 217 disposed between the first dichroic mirror 214a and a reflective light valve 230. After passing through the first dichroic mirror 214a, the first light beam 212a′ provided by the first light source assembly 212a is converged by the lens 217 onto the reflective light valve 230. After passing through the first dichroic mirror 214a, the second light beam 212b′ provided by the first light source assembly 212b is converged by the lens 217 onto the reflective light valve 230. Furthermore, when the first light source assembly 212a and the second light source assembly 212b emit light simultaneously, after being reflected by the first dichroic mirror 214a, the second light beam 212b′ is merged with the first light beam 212a′. The merged light beam is then transmitted to the reflective light valve 230. The reflective light valve 230 may be a digital micro-mirror device or a reflective liquid crystal on silicon. In the embodiment, for example, the digital micro-mirrors device comprises a plurality of micro-mirrors (not shown). When the micro-mirror is ON, the first light beam 212a′ and the second light beam 212b′ are reflected by the micro-mirrors to a projection lens 220; and when the micro-mirror is OFF, the first light beam 212a′ and the second light beam 212b′ are deviated from the projection lens 220. Then, the first light beam 212a′ and the second light beam 212b′ reflected to the projection lens 220 are projected on the screen (now shown) to form images.

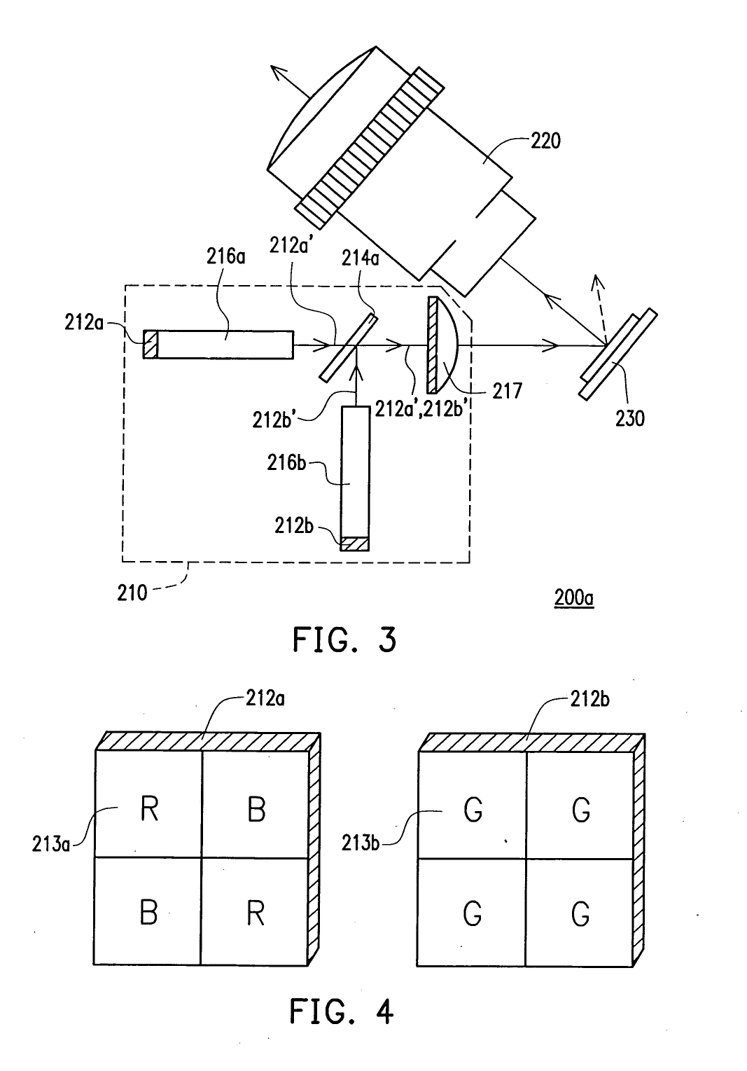

The first light integration rod 216a and the second light integration rod 216b in the illumination system 210 may restrain the diverge angle of the first light beam 212a′ and the second light beam 212b′ from ±180 degrees to ±30 degrees, so that the first light beam 212a′ and the second light beam 212b′ could be transmitted uniformly and effectively to the first dichroic mirror 214a. Therefore, the light loss during merging the lights can be reduced, and the luminance of the images projected by the optical projection apparatus 2001 can be enhanced. Moreover, the shape of the first light integration rod 216a and the second light integration rod 216b is either a rectangular as shown in FIG. 2 or a tapered column.

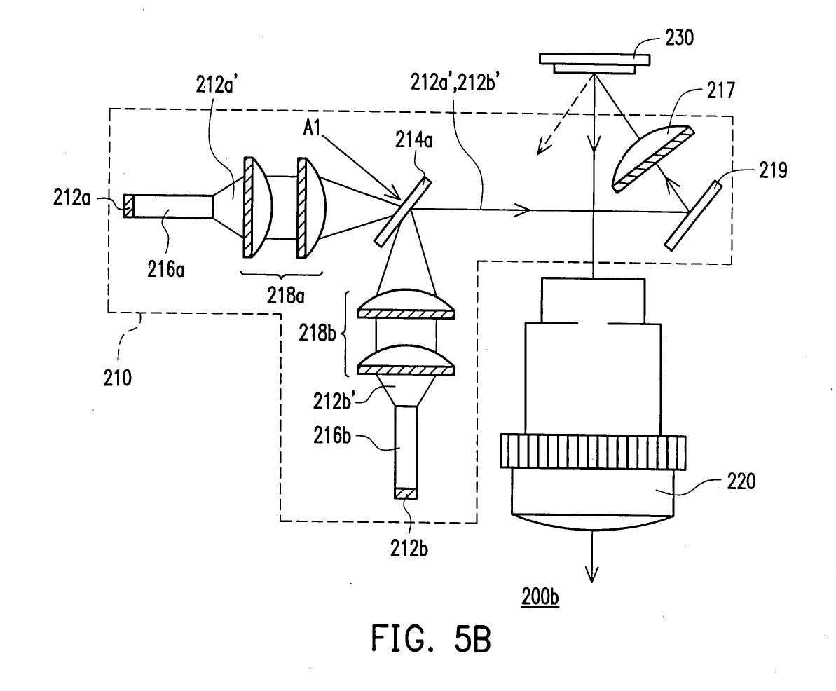

FIG. 4 is a schematic illustration of the first and the second light source assembly shown in FIG. 3. Referring to FIG. 3 and FIG. 4, in the above optical projection apparatus 200a, for example, the first light source assembly 212a includes a plurality of the first spot sources 213a, and the second light source assembly 212b further includes a plurality of second spot sources 213b. These first and second spot light sources could be light-emitting diode. Wherein, the colors of the first spot light sources 213a may be the same or different from each other, and the colors of the second spot light sources 213b may be the same or different from each other.

In one embodiment, for example, the first spot light source 213a includes a red light light-emitting diode R and a blue light emitting diode B, and the second spot light source 213b is green light light-emitting diode G, for example. The first dichroic mirror 214a allows the red and blue lights to pass through, and reflects the green light. In other words, the first light beam 212a′ is red light and/or blue light, and the second light beam 212b′ is green light. Moreover, the optical projection apparatus 200a projects colorful images through the mixture of red, blue and green lights.

It should be noted that, the colors of the first spotlight source 213a and the second spot light source 213b as mentioned are only exemplary. The present invention is not limited thereto. In other words, when the first spot light source 213a is one of the red-light light-emitting diode R, green-light light-emitting diode G and blue-light light-emitting diode B, the second spot light source 213b includes the remaining two light-emitting diodes. In the same way, when the second spot light source 213b is one of the red-light light-emitting diode R, green-light light-emitting diode G and blue-light light-emitting diode B, the first spot light source 213a includes the remaining two light-emitting diodes. Moreover, the first dichroic mirror 214a changes in accordance with the color change of the first spot light source 213a and the second spot light source 213b such that the first light beam 212a′ and the second light beam 212b′ are transmitted to the reflective light valve 230.

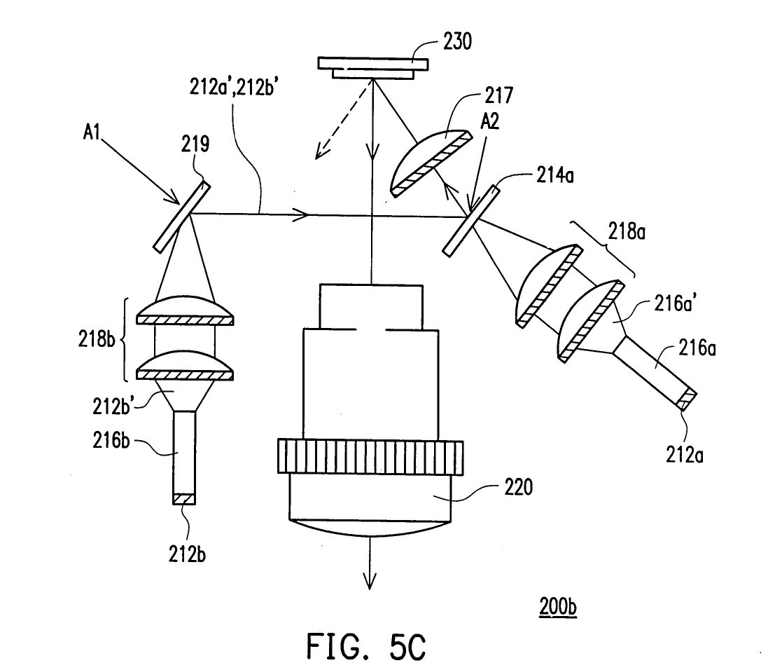

FIGS. 5A to 5C are schematic diagrams of the three optical projection apparatus in accordance with another embodiment of the present invention. Referring to FIG. 5A, the optical projection apparatus shown in FIG. 5A is similar to the optical projection apparatus 200a shown in FIG. 3. The difference is that, the illumination system 210 of the optical projection apparatus 200b further includes a first condenser 218a and a second condenser 218b. Wherein, the first condenser 218a is disposed between the first light integration rod 216a and the first dichroic mirror 214a, so as to further converge the first light beam 212a′; and the second condenser 218b is disposed between the second light integration rod 216b and the first dichroic mirror 214a, so as to further converge the second light beam 212b′. In one embodiment, for example, the first light beam 212a′ and the second light beam 212b′ are converged to the position A1, and the first dichroic mirror 214a is disposed on the position A1.

As described above, in the optical projection apparatus 200b, the first condenser 218a and the second condenser 218b converge the first light beam 212a′ and the second light beam 212b′ to the first dichroic mirror 214a, so as to increase the intensity of the first light beam 212a′ and the second light beam 212b′ projected to the reflective light valve 230. Therefore, the image projected by the projection lens 220 has higher luminance.

Referring to FIG. 5B, compared with FIG. 5A, the illumination system 210 shown in FIG. 5B further includes a reflector 219, for example. The reflector 219 is disposed on the transmission path of the first light beam 212a′ and the second light beam 212b′, so as to reflect the first light beam 212a′ and the second light beam 212b′ onto the reflective light valve 230.

Please refer to FIG. 5C, which is similar to FIG. 5B. Only differences between FIGS. 5C and 5B are described in the following. In FIG. 5C, for example, the reflector 219 is disposed between the second condenser 218b and the first dichroic mirror 214a, and on the transmission path of the second light beam 212b′, so as to reflect the second light beam 212b′ to the first dichroic mirror 214a. In one embodiment, for example, the reflector 219 is disposed on the converging point (the position A1) of the second light beam 212b′, the first light beam 212a′ is converged to the position A2, and the first dichroic mirror 214a is disposed on the position A2.

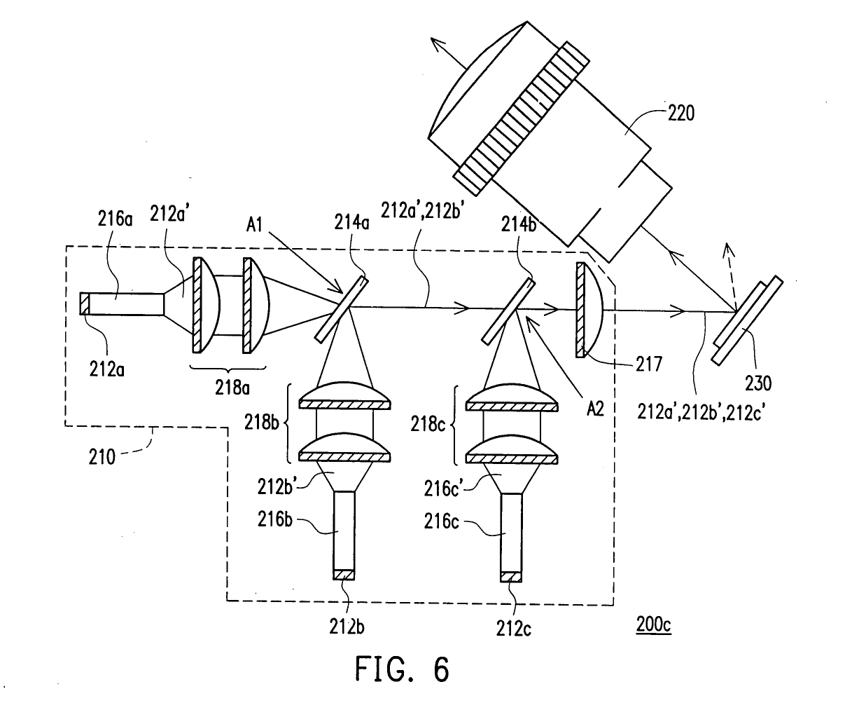

FIG. 6 is a schematic diagram of an optical projection apparatus in accordance with still another embodiment of the present invention. Referring to FIG. 6, the optical projection apparatus shown in FIG. 6 is similar to the optical projection apparatus 200b shown in FIG. 5A. The difference is that, the illumination system 210 of the optical projection apparatus 200c further includes a third light source assembly 212c, a third light integration rod 216c, a second dichroic mirror 214b and a third condenser 218c. Wherein, the second dichroic mirror 214b is disposed between the third light source assembly 212c and the reflective light valve 230, the third light integration rod 216c is disposed between the third light source assembly 212c and the second dichroic mirror 214b, and the third condenser 218c is disposed between the third light integration rod 216c and the second dichroic mirror 214b.

As described above, a third light beam 212c′ is provide by the third light source assembly 212c. The color of the third light beam 212c′ is different from that of the first light beam 212a′ and the second light beam 212b′. Furthermore, the third condenser 218c converges the third light beam 212c′ to the position A2. The second dichroic mirror 214b is disposed on the position A2, for example, so as to transmit the first light beam 212a′, the second light beam 212b′, and the third light beam 212c′ to the reflective light valve 230.

In the projection apparatus 200c as described above, after being reflected by the second dichroic mirror 214b, the third light beam 212c′ is transmitted to the reflective light valve 230. If the third light source assembly 212c, the first light source assembly 212a and/or the second light source assembly 212b emit light simultaneously, after being reflected by the second dichroic mirror 214b, the third light beam 212c′ merges with the first light beam 212a′ and/or the second light beam 212b′, and is then transmitted to the reflective light valve 230 simultaneously. Then, the first light beam 212a′, the second light beam 212b′ and the third light beam 212c′ reflected to the projection lens 220 are projected on the screen (now shown) to form images.

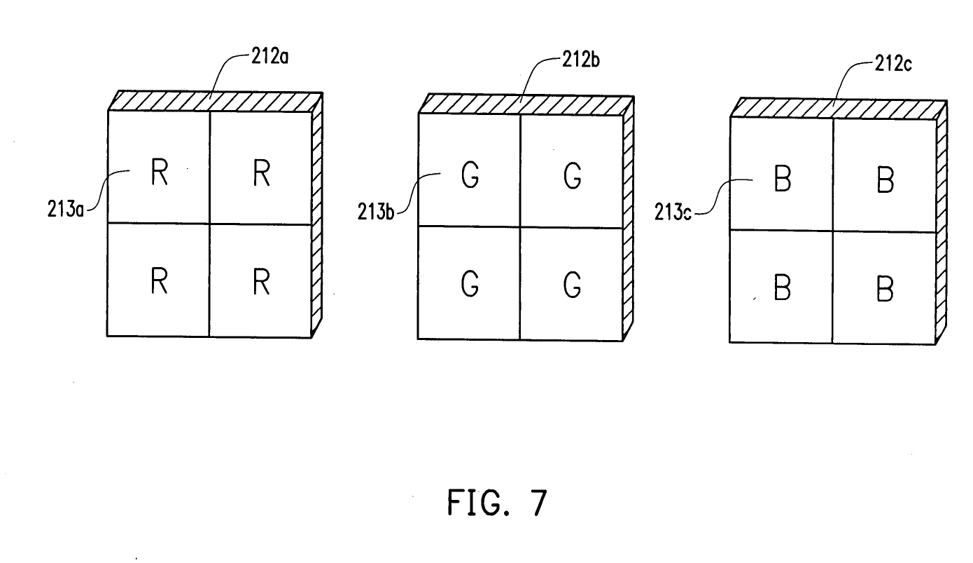

FIG. 7 is a schematic diagram of the first light source assembly, the second light source assembly and the third light source assembly shown in FIG. 6. Referring to FIG. 6 and FIG. 7, in the above described optical projection apparatus 200c, for example, the third light source assembly 212c includes a plurality of third spot light sources 213c, such as light-emitting diode. The colors of these light-emitting diodes may be the same or different from each other. In one embodiment, for example, the first spot light source 213a is red-light light-emitting diode R, the second spot light source 213b is green-light light-emitting diode G, and the third spot light source 213c is blue-light light-emitting diode B.

Since the optical projection apparatus 200c has three light source assemblies 212a, 212b and 212c, more light-emitting diodes are used. Using more light-emitting diodes leads to higher intensity of blue light, red light and green light. Therefore, the image projected by the optical projection apparatus 200c has higher luminance.

It should be mentioned that, the colors of the first spot light source 213a, the second spot light source 213b and the third spot light source 213c as mentioned above are only exemplary, not limited the present invention. In other words, the colors of the first spot light source 213a, the second spot light source 213b and the third spot light source 213c can be adjusted according requirements, if needed. Moreover, the first dichroic mirror 214a and the second dichroic mirror 214b change in accordance with the color change of the first spot light source 213a, the second spot light source 213b and the third spot light source 213c, such that the first light beam 212a′ the second light beam 212b′ and the third light beam 212c′ can be transmitted to the reflective light valve 230.

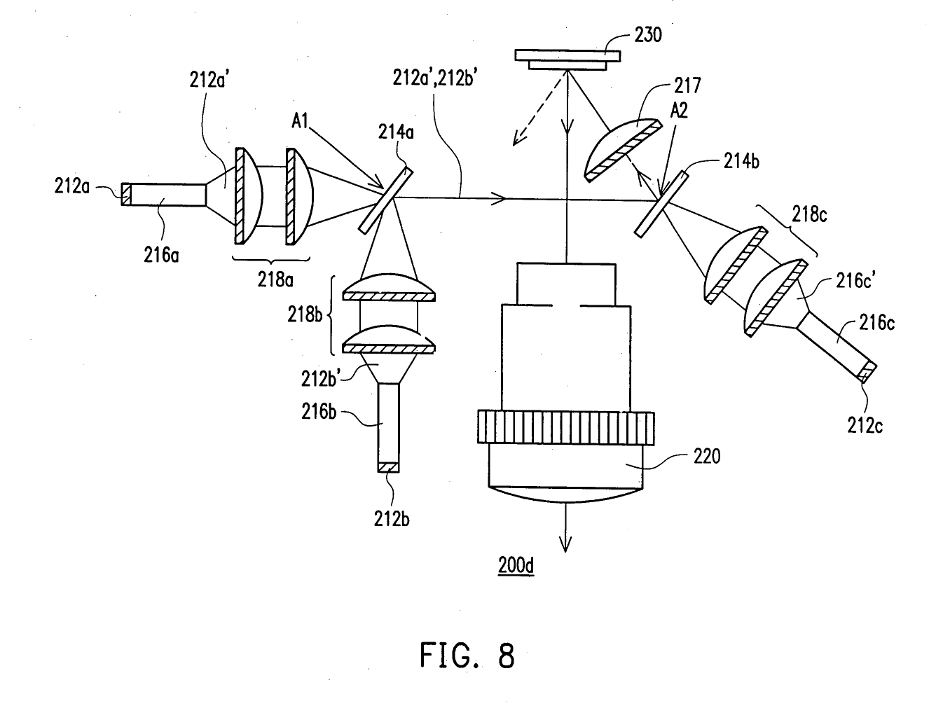

FIG. 8 is a schematic diagram of an optical projection apparatus in accordance with yet another embodiment of the invention. Referring to FIG. 8, the optical projection apparatus shown in FIG. 8 is similar to the optical projection apparatus 200c shown in FIG. 6. The difference is that, the second dichroic mirror 214b in the optical projection apparatus 200c shown in FIG. 6 allows the first light beam 212a′ and the third light beam 212b′ to pass through, and reflects the third light beam 212c′. However, in the optical projection apparatus 200d shown in FIG. 8, the second dichroic mirror 214b allows the third second light beam 212c′ to pass through, and reflects the first light beam 212a′ and the second light beam 212b′.

In summary, the optical projection apparatus of the present invention includes at least the following advantages:
1. The first light integration rod and the second light integration rod may restrain the diverge angle of the first light beam 212a′ and the second light beam 212b′ respectively to ±30 degrees, so as to reduce the light loss when the first light beam merges with the second light beam. Therefore, the image projected by the optical projection apparatus of the invention has higher luminance.
2. A third light source assembly and a third light integration rod can further be included in the optical projection apparatus of the present invention, so that the image projected by the optical projection apparatus has higher luminance.
3. The present invention may utilize condenser to converge light, so as to further increase the luminance of the image projected by the optical projection apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An optical projection apparatus, comprising:
an illumination system, comprising:
a first light source assembly for providing a first light beam;
a second light source assembly for providing a second light beam, wherein the spectrum of said first light beam and said second light beam are different;
a first dichroic mirror disposed on the transmission path of said first light beam and said second light beam, wherein said first light beam passes through said first dichroic mirror, and said second light beam is reflected by said first dichroic mirror, the transmission path of said second light beam after being reflected by said first dichroic mirror coincide with the transmission path of said first light beam after passing through said first dichroic mirror;
a first light integration rod disposed between said first light source assembly and said first dichroic mirror;
a second light integration rod disposed between said second light source assembly and said first dichroic mirror;
a projection lens disposed on the transmission path of said first light beam and said second light beam; and
a reflective light valve disposed between said illumination system and said projection lens and on the transmission path of said first light beam and said second light beam.

2. The optical projection apparatus of claim 1, wherein said first light source assembly comprises a plurality of first spot light sources, and said second light source assembly comprises a plurality of second spot light sources.

3. The optical projection apparatus of claim 2, wherein said first spot light sources and said second spot light sources comprise light-emitting diodes.

4. The optical projection apparatus of claim 3, wherein the colors of said first spot light sources are the same or different from each other, and the colors of said second spot light sources are the same or different from each other.

5. The optical projection apparatus of claim 1, wherein said illumination system further comprises:
a first condenser disposed between said first light integration rod and said first dichroic mirror to converge said first light beam; and
a second condenser disposed between said second light integration rod and said first dichroic mirror to converge said second light beam.

6. The optical projection apparatus of claim 5, wherein said first light beam and said second light beam are converged to a first position, and said first dichroic mirror is disposed on said first position.

7. The optical projection apparatus of claim 5, wherein said illumination system further comprises a reflector disposed on the transmission path of said second light beam to reflect said second light beam onto said first dichroic mirror.

8. The optical projection apparatus of claim 7, wherein said second light beam and said first light beam are converged to a first position and a second position, respectively, and said reflector and said first dichroic mirror are disposed on said first position and said second position, respectively.

9. The optical projection apparatus of claim 1, wherein said illumination system further comprises:
a third light source assembly for providing a third light beam;
a second dichroic mirror disposed between said third light source assembly and said reflective light valve, making the transmission path of said first light beam, said second light beam and said third light beam identical; and
a third light integration rod disposed between said third light source assembly and said second dichroic mirror.

10. The optical projection apparatus of claim 9, wherein said second dichroic mirror allows said first light beam and said second light beam to pass through, and reflects said third light beam.

11. The optical projection apparatus of claim 9, wherein said second dichroic mirror allows said third light beam to pass through, and reflects said first light beam and said second light beam.

12. The optical projection apparatus of claim 9, wherein said third light source assembly comprises a plurality of third spot light sources.

13. The optical projection apparatus of claim 12, wherein said third light sources comprise light-emitting diodes.

14. The optical projection apparatus of claim 13, wherein the colors of said third light sources are the same or different from each other.

15. The optical projection apparatus of claim 9, wherein said illumination system further comprises a third condenser disposed between said third light integration rod and said second dichroic mirror to converge said third light beam.

16. The optical projection apparatus of claim 15, wherein said third light beam is converged on a second position, and said second dichroic mirror is disposed on said second position.

17. The optical projection apparatus of claim 1, wherein said reflective light valve comprises a digital micro-mirror or a reflective liquid crystal on silicon.

18. The optical projection apparatus of claim 1, wherein said illumination system further comprises a reflector disposed on the transmission path of said second light beam to reflect said second light beam to said first dichroic mirror.
